(19) United States
(12) Patent Application Publication
(10) Pub. No.: US 2015/0378698 A1
(43) Pub. Date: Dec. 31, 2015

(54) INTEGRATED COMPILATION MODES FOR DATA FLOW CODE GENERATION

(71) Applicant: International Business Machines Corporation, Armonk, NY (US)

(72) Inventors: Scott Boag, Woburn, MA (US); Moshe M. E. Matsa, Cambridge, MA (US); Kristoffer H. Rose, Poughkeepsie, NY (US); Naoto Sato, Kawasaki-shi (JP); Lionel A. S. Villard, Yorktown Heights, NY (US)

(21) Appl. No.: 14/317,265

(22) Filed: Jun. 27, 2014

(51) Int. Cl. G06F 9/45; G06F 9/44

(52) U.S. Cl. CPC G06F 8/49; G06F 8/30

(57) ABSTRACT

Aspects of the present invention provide a solution for compiling data in a plurality of modes. In an embodiment, at least one optimal mode is specified for each of a set of program language constructs and each of a set of language primitives in a first language. A set of optimal mode code is generated in the at least one mode in a second language. A set of bridge code is generated. A set of additional mode code is generated in a plurality of other modes in the second language, wherein the generating utilizes the bridge code. The generated optimal mode code and additional mode code is compiled.

### STATEMENT REGARDING PRIOR DISCLOSURE BY THE INVENTOR OR A JOINT INVENTOR

The following disclosure is submitted under 35 U.S.C. 102(b)(1)(a): DISCLOSURE: “IBM Websphere DataPower firmware release 6.0.0” available to the public on Jun. 28, 2013.

### TECHNICAL FIELD

The subject matter of this invention relates generally to software compilers. More specifically, aspects of the present invention provide a solution for improved integrated compilation modes for data flow generation.

### BACKGROUND

Software compilers are used extensively for translating source code in a first language to a second target language. This can be done in certain modes, for instance a streaming mode, a memory-store mode, an object model creation mode, and many others. Traditionally, compilers for data processing languages have been designed to work in a single mode. For instance, the generation of SAX vs DOM code for the XML language is designed to work best in one mode. This design results in code that is generated to favor certain workloads over other possible modes.

In recent years, work has been done to design ‘cursor’ Application Programming Interfaces (APIs) capable of accessing data using multiple modes. However, these attempts require later conversion of data after compilation.

### SUMMARY

In general, aspects of the present invention provide a solution for compiling data in a plurality of modes. In an embodiment, at least one optimal mode is specified for each of a set of program language constructs and each of a set of language primitives in a first language. A set of optimal mode code is generated in the at least one mode in a second language. A set of bridge code is generated. A set of additional mode code is generated in a plurality of other modes in the second language, wherein the generating utilizes the bridge code. The generated optimal mode code and additional mode code is compiled.

A first aspect of the invention provides a method for compiling data in a plurality of modes, the method comprising: specifying at least one optimal mode for each of a set of program language constructs and each of a set of language primitives in a first language; generating a set of optimal mode code in the at least one mode in a second language; generating a set of bridge code; generating a set of additional mode code in a plurality of other modes in the second language, wherein the generating utilizes the bridge code; and compiling the generated optimal mode code and additional mode code.

A second aspect of the invention provides a system for compiling data in a plurality of modes, comprising at least one computer device that performs a method, comprising: specifying at least one optimal mode for each of a set of program language constructs and each of a set of language primitives in a first language; generating a set of optimal mode code in the at least one mode in a second language; generating a set of bridge code; generating a set of additional mode code in a plurality of other modes in the second language, wherein the generating utilizes the bridge code; and compiling the generated optimal mode code and additional mode code.

A third aspect of the invention provides a computer program product embodied in a computer readable hardware medium for compiling data in a plurality of modes, which, when executed, performs a method comprising: specifying at least one optimal mode for each of a set of program language constructs and each of a set of language primitives in a first language; generating a set of optimal mode code in the at least one mode in a second language; generating a set of bridge code; generating a set of additional mode code in a plurality of other modes in the second language, wherein the generating utilizes the bridge code; and compiling the generated optimal mode code and additional mode code.

A fourth aspect of the present invention provides a method for deploying an application for compiling data in a plurality of modes, comprising: providing a computer infrastructure being operable to: specify at least one optimal mode for each of a set of program language constructs and each of a set of language primitives in a first language; generate a set of optimal mode code in the at least one mode in a second language; generate a set of bridge code; generate a set of additional mode code in a plurality of other modes in the second language, wherein the generating utilizes the bridge code; and compile the generated optimal mode code and additional mode code.

Still yet, any of the components of the present invention could be deployed, managed, serviced, etc., by a service provider who offers to implement passive monitoring in a computer system.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system according to embodiments of the present invention.

FIG. 2 shows an example flow diagram according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Current methods of compiling code for data processing languages tend to favor a certain workload or mode over others. Attempts have been made to develop APIs that can dynamically access data using multiple modes, but code is not generated in a manner that mixes the compilation modes opportunistically. Embodiments of the current method of compiling include such mixing of compilation modes, utilizing bridge code generated by the compiler from special integrated local compilation modes included in the compiler. This allows for an opportunistic code generation using higher-order rewriting in order to define all language constructs and language primitives in each desired mode in a single workload.

As indicated above, aspects of the present invention provide a solution for compiling data in a plurality of modes. In an embodiment, at least one optimal mode is specified for each of a set of program language constructs and each of a set of language primitives in a first language. A set of optimal mode code is generated in the at least one mode in a second language. A set of bridge code is generated, and a set of additional mode code is generated in a plurality of other modes in the second language, wherein the generating utilizes the bridge code. The generated optimal mode code and additional mode code is compiled.

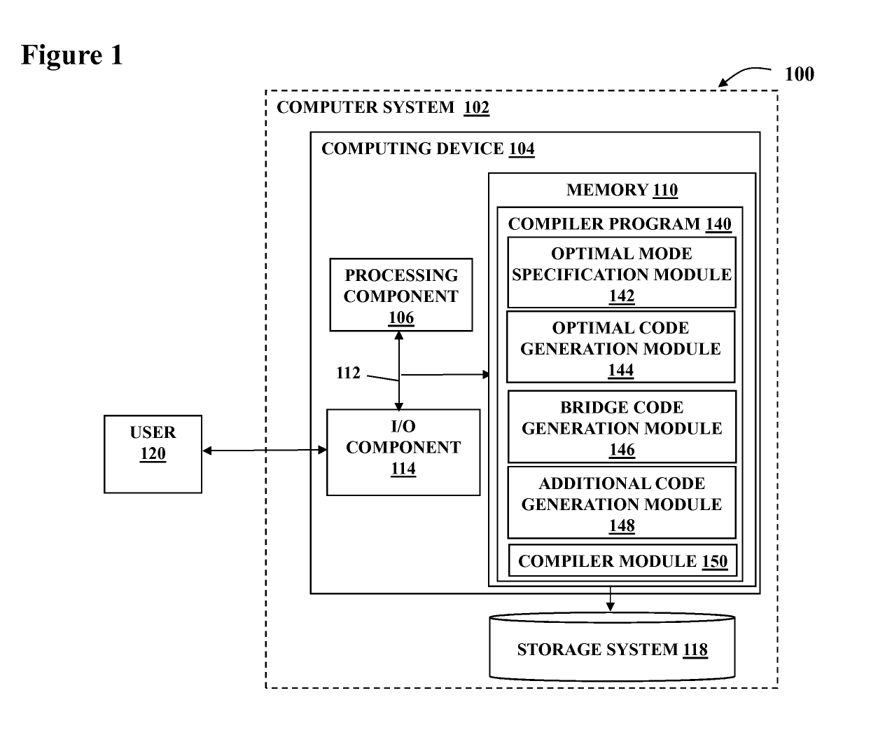

Turning to the drawings, FIG. 1 shows an illustrative environment 100 for compiling data in a plurality of modes. To this extent, environment 100 includes a computer system 102 that can perform a process described herein in order to compile data in a plurality of modes. In particular, computer system 102 is shown including a computing device 104 that includes a compiler program 140, which makes computing device 104 operable to compile data in a plurality of modes by performing processes described herein.

Computing device 104 is shown including a processing component 106 (e.g., one or more processors), a memory 110, a storage system 118 (e.g., a storage hierarchy), an input/output (I/O) component 114 (e.g., one or more I/O interfaces and/or devices), and a communications pathway 112. In general, processing component 106 executes program code, such as compiler program 140, which is at least partially fixed in memory 110. To this extent, processing component 106 may comprise a single processing unit, or be distributed across one or more processing units in one or more locations.

Memory 110 also can include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may comprise any known type of temporary or permanent data storage media, including magnetic media, optical media, random access memory (RAM), read-only memory (ROM), a data cache, a data object, etc. Moreover, similar to processing component 106, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O component 114 can comprise one or more human I/O devices, which enable a human user 120 to interact with computer system 102 and/or one or more communications devices to enable a system user 120 to communicate with computer system 102 using any type of communications link.

To this extent, compiler program 140 can manage a set of interfaces (e.g., graphical user interface(s), application program interface, and/or the like) that enable human and/or system users 120 to interact with compiler program 140. Users 120 could include system administrators who want to compile data in a plurality of modes, among others. Further, compiler program 140 can manage (e.g., store, retrieve, create, manipulate, organize, present, etc.) the data in storage system 118 using any solution.

In any event, computer system 102 can comprise one or more computing devices 104 (e.g., general purpose computing articles of manufacture) capable of executing program code, such as compiler program 140, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, compiler program 140 can be embodied as any combination of system software and/or application software. In any event, the technical effect of computer system 102 is to provide processing instructions to computing device 104 in order to compile data in a plurality of modes.

Further, compiler program 140 can be implemented using a set of modules 142-150. In this case, a module 142-150 can enable computer system 102 to perform a set of tasks used by compiler program 140, and can be separately developed and/or implemented apart from other portions of compiler program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 can have only a portion of compiler program 140 fixed thereon (e.g., one or more modules 142-150). However, it is understood that computer system 102 and compiler program 140 are only representative of various possible equivalent computer systems that may perform a process described herein. To this extent, in other embodiments, the functionality provided by computer system 102 and compiler program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, compiler program 140 enables computer system 102 to compile data in a plurality of modes. To this extent, compiler program 140 is shown including an optimal mode specification module 142, an optimal code generation module module 144, a bridge code generation module 146, an additional code generation module 148, and a compiler module 150.

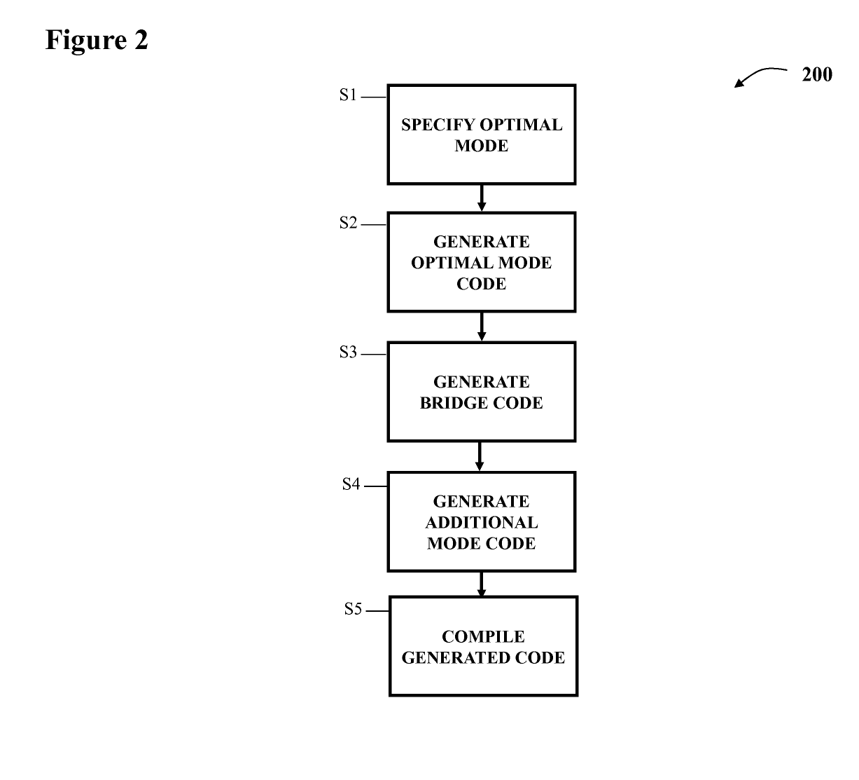

Turning now to FIG. 2, an example flow diagram according to embodiments of the invention is shown. In one embodiment, a method 200 is disclosed. As illustrated, in S1, at least one optimal mode is specified, for instance using optimal mode module 142 (FIG. 1), as executed by computer system 102 (FIG. 1). In some embodiments, at least one optimal mode is specified, and in some cases multiple optimal modes may be specified in a single workload for compiling data. The optimal mode may be defined for some or all of the language constructs and some or all of the language primitives included in the data, which is in a first language, to be compiled. In some embodiments, a compiler developer, which may include user 120 (FIG. 1), who creates compiler program 140 may only need to specify optimal modes for the language constructs and the language primitives, and other mode codes are generated automatically as further described below.

The modes specified can include any now known or later developed modes used in compilation of data. For example, the modes used may include, but are not limited to, a stream mode, an update mode, a local mode, a test mode, an iterate mode, and a tuple-add mode. These modes may use a uniform notation, such as that used in higher-order rewriting.

Further regarding S1, in some embodiments, certain language constructs and language primitives may frequently be specified to be generated in certain optimal modes. For example, for each language construct similar to a ‘for . . . ’ construct, which includes iteration constructs, a streaming mode may be specified. This can result in a repeated loop body that can be sent to the output. In another example, iteration type language constructs may also be specified to be generated in a test mode. This is because for a loop, a test mode may simply test if the result is empty. For ‘plus’ language constructs, a store mode may be specified. Advantageously, some language constructs, for example ‘if . . . ’ and ‘let . . . ’ constructs may be able to generate optimal code for all possible modes, rather than one or a few modes as with some other constructs.

In S2, optimal code generation module 144 (FIG. 1), as executed by computer system 102 (FIG. 1), generates a set of optimal mode code in the at least one specified optimal mode in a second language, for each of the set of language constructs and each of the set of language primitives that are in the data. First and second languages may include any known or later developed languages, including but not limited to XQuery, JSONiq, XSLT, and SQL. The generation of the optimal mode code can include any means now known or later developed of generating a compiler code for a particular mode. However, in some embodiments of the current invention, it is possible to switch, automatically, between different optimal modes even during the execution of generating the optimal mode code.

In S3, bridge code generation module 146 (FIG. 1), as executed by computer system 102 (FIG. 1), generates a set of bridge code. In some embodiments, higher-order rewriting can be used to generate the bridge code. The bridge code generated allows for the optimal mode code generated to be used to ‘bridge’ the generation of the other modes. This bridging allows for the generation of code for a plurality of modes, despite only specifying one or a few optimal modes, during the single workload of a single compiling method. Further, this allows for a static choice of the optimal mode or a dynamic choice of the optimal mode used for compiling.

In S4, additional code generation module 148 (FIG. 1), as executed by computer system 102 (FIG. 1), generates a set of additional mode code, in a plurality of other modes which are not the specified optimal mode or modes, in the second language. The generating of the additional modes utilizes the bridge code generated in S3 and higher-order rewriting.

In S5, compiler module 150 (FIG. 1), as executed by computer system 102 (FIG. 1), compiles the generated optimal mode code and the generated additional mode code into the end set of code in the second language. This set of code may include any compiled data format and language, such as executable code, for instance.

While shown and described herein as a method and system for compiling data in a plurality of modes, it is understood that aspects of the invention further provide various alternative embodiments. For example, in one embodiment, the invention provides a computer program fixed in at least one computer-readable medium, which when executed, enables a computer system to compile data in a plurality of modes. To this extent, the computer-readable medium includes program code, such as compiler program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as compiler program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for remediating a migration-related failure. In this case, a computer system, such as computer system 102 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, if and where used herein do not denote any order, quantity, or importance, but rather are used to distinguish one element from another, and the terms “a” and “an” herein do not denote a limitation of quantity, but rather denote the presence of at least one of the referenced item. The modifier “approximately”, where used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for compiling data in a plurality of modes, the method comprising:
specifying at least one optimal mode for each of a set of program language constructs and each of a set of language primitives in a first language;
generating a set of optimal mode code in the at least one mode in a second language;
generating a set of bridge code;
generating a set of additional mode code in a plurality of other modes in the second language, wherein the generating utilizes the bridge code; and
compiling the generated optimal mode code and additional mode code.

2. The method of claim 1, wherein the plurality of modes includes a group consisting of: stream, update, local, test, iterate, and tuple-add modes.

3. The method of claim 1, wherein the specifying at least one mode comprises specifying a plurality of modes.

4. The method of claim 3, further comprising:
switching of the specified optimal mode during generation of the set of optimal mode code.

5. The method of claim 1, wherein the set of bridge code is generated using higher order rewriting.

6. The method of claim 5, wherein the generation of the set of bridge code is one of: static or dynamic.

7. The method of claim 1, wherein for an iteration language construct, the optimal mode is chosen from a group consisting of at least one of: stream and test modes.

8. The method of claim 1, wherein for a plus language construct, the optimal mode consists of a store mode.

9. A system for compiling data in a plurality of modes, comprising at least one computer device that performs a method, comprising:
specifying at least one optimal mode for each of a set of program language constructs and each of a set of language primitives in a first language;
generating a set of optimal mode code in the at least one mode in a second language;
generating a set of bridge code;
generating a set of additional mode code in a plurality of other modes in the second language, wherein the generating utilizes the bridge code; and
compiling the generated optimal mode code and additional mode code.

10. The system of claim 9, the method further comprising:
wherein the plurality of modes includes a group consisting of: stream, update, local, test, iterate, and tuple-add modes.

11. The system of claim 9, the method further comprising:
wherein the specifying at least one mode comprises specifying a plurality of modes.

12. The system of claim 11, the method further comprising:
switching of the specified optimal mode during generation of the set of optimal mode code.

13. The system of claim 9, the method further comprising:
wherein the set of bridge code is generated using higher order rewriting.

14. The system of claim 13, the method further comprising:
wherein the generation of the set of bridge code is one of: static or dynamic.

15. The system of claim 9, the method further comprising:
wherein for an iteration language construct, the optimal mode is chosen from a group consisting of at least one of: stream and test modes.

16. The system of claim 9, the method further comprising:
wherein for a plus language construct, the optimal mode consists of a store mode.

17. A computer program product embodied in a computer readable medium for compiling data in a plurality of modes, which, when executed, performs a method comprising:
specifying at least one optimal mode for each of a set of program language constructs and each of a set of language primitives in a first language;
generating a set of optimal mode code in the at least one mode in a second language;
generating a set of bridge code;
generating a set of additional mode code in a plurality of other modes in the second language, wherein the generating utilizes the bridge code; and
compiling the generated optimal mode code and additional mode code.

18. The computer program product of claim 17, the method further comprising:
wherein the plurality of modes includes a group consisting of: stream, update, local, test, iterate, and tuple-add modes.

19. The computer program product of claim 17, the method further comprising:
wherein the specifying at least one mode comprises specifying a plurality of modes.

20. The computer program product of claim 19, the method further comprising:
switching of the specified optimal mode during generation of the set of optimal mode code.

21. The computer program product of claim 17, the method further comprising:
wherein the set of bridge code is generated using higher order rewriting.

22. The computer program product of claim 21, the method further comprising:
wherein the generation of the set of bridge code is one of: static or dynamic.

23. The computer program product of claim 17, the method further comprising:
wherein for an iteration language construct, the optimal mode is chosen from a group consisting of at least one of: stream and test modes.

24. The computer program product of claim 17, the method further comprising:
wherein for a plus language construct, the optimal mode consists of a store mode.

25. A method for deploying an application for compiling data in a plurality of modes, comprising:
provide a computer infrastructure being operable to:
specify at least one optimal mode for each of a set of program language constructs and each of a set of language primitives in a first language;
generate a set of optimal mode code in the at least one mode in a second language;
generate a set of bridge code;
generate a set of additional mode code in a plurality of other modes in the second language, wherein the generating utilizes the bridge code; and
compile the generated optimal mode code and additional mode code.
